(19) United States
(12) Patent Application Publication
(10) Pub. No.: US 2015/0055914 A1
(43) Pub. Date: Feb. 26, 2015

(54) ACTIVE OPTICAL CONNECTOR AND SYSTEMS COMPRISING

(71) Applicant: GENERAL ELECTRIC COMPANY, Schenectady, NY (US)

(72) Inventors: Michael Joseph Dell'Anno, Clifton Park, NY (US); Wesley Michael Skeffington, Clifton Park, NY (US); James Gerard Lopez, East Schodack, NY (US)

(73) Assignee: GENERAL ELECTRIC COMPANY, Schenectady, NY (US)

(21) Appl. No.: 13/971,909

(22) Filed: Aug. 21, 2013

(51) Int. Cl. G02B 6/26; G02B 6/42

(52) U.S. Cl. CPC G02B 6/26; G02B 6/4296
USPC 385/28

(57) ABSTRACT

Simple yet robust active optical connectors are provided comprising: (a) a first connecting module configured to be joined to a first fiber optic cable, the first connecting module being configured to receive a first transmission signal from a signal carrying fiber of the first fiber optic cable and to actively convert the first transmission signal into an optical connection signal; and (b) a second connecting module configured to be joined to a second fiber optic cable, the second connecting module being configured to receive the optical connection signal and to propagate a second transmission signal within a signal carrying fiber of the second fiber optic cable; wherein the first connecting module comprises at least one optical amplifier, and wherein the first and second connecting modules are configured to couple such that the optical connection signal is transmitted and received across a light transmissive interface.

### BACKGROUND

The present invention relates to optical communications junctions between fiber optic cables. In particular the present invention relates to active optical connectors, components of such simplified optical connectors, and systems comprising such optical connectors.

Existing fiber optic communications connectors are prone to reliability and quality problems, especially when used to remotely join an installation such as a subsea fluid processing unit to a fiber optic data transmission network. This is in part due to the need to precisely align a pair of glass or plastic signal carrying fibers having very small diameters with one another within the connector. The surface finish of the ends of the two fiber optic cables being connected must be clean and free of debris. In addition, the mating surfaces of the two signal carrying fibers must be both parallel and in physical contact with each other. Challenges to successfully coupling two fiber optic cables are compounded in subsea operations which may require the use of remotely operated vehicles (robots) to couple a first fiber optic cable to a second fiber optic cable under conditions where marine snow and/or other particulate contaminants are present in the underwater environment. Modern solutions to the problem of creating remote, on-site connections between fiber optic cables have focused on complex, precision mechanical alignment of the fiber optic cables to be coupled, and sealing systems for the same.

The considerable ingenuity displayed, and achievements to date in this field of endeavor notwithstanding, further improvements are desirable. The present invention for its part provides a set of simple, yet elegant, solutions to the very real problems associated with creating robust and reliable connections between fiber optic cables.

### BRIEF DESCRIPTION

In one embodiment, the present invention provides an optical connector comprising: (a) a first connecting module configured to be joined to a first fiber optic cable, the first connecting module being configured to receive a first transmission signal from a signal carrying fiber of the first fiber optic cable and to actively convert the first transmission signal into an optical connection signal; and (b) a second connecting module configured to be joined to a second fiber optic cable, the second connecting module being configured to receive the optical connection signal and to propagate a second transmission signal within a signal carrying fiber of the second fiber optic cable; wherein the first connecting module comprises at least one optical amplifier, and wherein the first and second connecting modules are configured to couple such that the optical connection signal is transmitted and received across a light transmissive interface.

In an alternate embodiment, the present invention provides an optical connector comprising: (a) a first connecting module configured to be joined to a first fiber optic cable, the first connecting module being configured to receive a first transmission signal from a signal carrying fiber of the first fiber optic cable and to actively convert the first transmission signal into an optical connection signal; and (b) a second connecting module configured to be joined to a second fiber optic cable, the second connecting module being configured to receive the optical connection signal and to actively convert the optical connection signal into a second transmission signal and to propagate the second transmission signal within a signal carrying fiber of the second fiber optic cable; wherein the first and second connecting modules are configured to couple such that the optical connection signal is transmitted and received across a light transmissive interface.

In yet another embodiment, the present invention provides optical connector comprising: (a) a first connecting module configured to be hermetically joined to a first fiber optic cable, the first connecting module comprising: (i) a first receiver configured to receive a first transmission signal characterized by a first transmission signal power from a signal carrying fiber of the first fiber optic cable and to convert the first transmission signal into a first electric signal; (ii) a first conversion system configured to convert the first electric signal into an optical connection signal characterized by an optical connection signal power at least an order of magnitude greater than the first transmission signal power; (iii) a first light transmissive window configured to transmit the optical connection signal; (b) a second connecting module configured to be hermetically joined to a second fiber optic cable, the second connecting module comprising: (i) a second light transmissive window configured to transmit the optical connection signal; (ii) a second receiver configured to receive the optical connection signal and to convert the optical connection signal into a second electric signal; (iii) a second conversion system configured to convert the second electric signal into a second transmission signal and to propagate the second transmission signal within a signal carrying fiber of the second fiber optic cable; wherein the first and second connecting modules are configured to couple such that the optical connection signal is transmitted and received across a light transmissive interface having a cross-sectional area at least two orders of magnitude greater than a corresponding cross-sectional area of the signal carrying fibers of the first and second fiber optic cables.

In yet another embodiment, the present invention provides an optical connector component comprising: a connecting module configured to be joined to a fiber optic cable, the connecting module being configured to receive a transmission signal from a signal carrying fiber of the fiber optic cable and to actively convert the transmission signal into an optical connection signal; wherein the connecting module is configured to couple with a second connecting module and transmit the optical connection signal to the second connecting module across a light transmissive interface.

### BRIEF DESCRIPTION OF THE DRAWING FIGURES

Various features, aspects, and advantages of the present invention will become better understood when the following detailed description is read with reference to the accompanying drawings in which like characters may represent like parts throughout the drawings. Unless otherwise indicated, the drawings provided herein are meant to illustrate key inventive features of the invention. These key inventive features are believed to be applicable in a wide variety of systems which comprising one or more embodiments of the invention. As such, the drawings are not meant to include all conventional features known by those of ordinary skill in the art to be required for the practice of the invention.

FIG. 1 represents an optical connector illustrating one or more embodiments of the present invention;

FIG. 2 represents an optical connector illustrating one or more embodiments of the present invention;

FIG. 3 represents an optical connector illustrating one or more embodiments of the present invention;

FIG. 4 represents an optical connector illustrating one or more embodiments of the present invention;

FIG. 5 represents an optical connector illustrating one or more embodiments of the present invention;

FIG. 6 represents an optical connector illustrating one or more embodiments of the present invention;

FIG. 7 represents an optical connector illustrating one or more embodiments of the present invention;

FIG. 8 represents an optical connector illustrating one or more embodiments of the present invention;

FIG. 9 represents an optical connector illustrating one or more embodiments of the present invention;

FIG. 10 represents an optical amplifier which may be used in accordance with one or more embodiments of the present invention;

FIG. 11 represents an optical amplifier which may be used in accordance with one or more embodiments of the present invention; and

FIG. 12 represents an optical connector illustrating one or more embodiments of the present invention.

### DETAILED DESCRIPTION

In the following specification and the claims, which follow, reference will be made to a number of terms, which shall be defined to have the following meanings.

The singular forms “a”, “an”, and “the” include plural referents unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The optical connectors provided by the present invention serve as robust, yet relatively simple optical communications junctions through which data may be passed from a first fiber optic cable to a second fiber optic cable. Such connection of two or more fiber optic cables may be achieved without the need for precision alignment and/or propinquity of the signal carrying fibers of the fiber optic cables. A precise and close spatial relationship between the signal carrying fibers of two different fiber optic cables configured to exchange data is a condition typically required for reliable data transmission between the two fiber optic cables. The optical connectors provided by the present invention represent a novel and useful alternative to known optical communications junctions. Various types of data may be transmitted through the optical connectors provided by the present invention. Such data include any data types which may be transmitted through a fiber optic data transmission network, for example, analog data and digital data. As will be appreciated by those of ordinary skill in the art, an optical transmission signal may be modulated by in various ways, for example, by means of amplitude modulation, phase modulation, pulse modulation, and frequency modulation, and carry data in a digital format. In other applications data may be transmitted as essentially continuous optical signals corresponding to analog data. For example, in certain embodiments the optical connector provided by the present invention may be used to transmit a continuous optical signal from a sensor deployed within an installation. In an alternate embodiment, the optical connector provided by the present invention may be used to transmit an essentially continuous optical signal, which has been modulated by one or more acoustic signals. In some embodiments, the optical connector provided by the present invention may be used to transmit data initially generated as an analog signal, for example, a radio frequency signal which is subsequently converted into an optical signal and propagated through a fiber optic data transmission network comprising the optical connector. Accordingly the term “data” should be construed to include any signal which may be transmitted by the optical connectors provided by the present invention.

The design and function of the optical connectors disclosed herein are such that a first fiber optic cable need only deliver a first transmission signal to a first connecting module of the optical connector. The first connecting module is equipped to actively convert the first transmission signal into an enhanced optical signal, at times herein referred to as an optical connection signal, which is then transmitted across a light transmissive interface to a second connecting module of the optical connector. The second connecting module propagates a second transmission signal within a second fiber optic cable thereby completing the transmission of data contained within the first transmission signal across the optical communications junction.

The light transmissive interface may be any suitable interface across which an optical connection signal may be passed. In certain embodiments, the light transmissive interface is a fluid-filled gap between a light transmissive window of the first connecting module and a light transmissive window of the second connecting module. In one embodiment, the fluid-filled gap contains primarily seawater. In an alternate embodiment, the fluid-filled gap contains primarily air. The dimensions of the light transmissive interface are constrained only by the requirement that the optical connection signal travel from the first connecting module to the second connecting module with sufficient signal fidelity to reliably communicate data from a first fiber optic cable to a second fiber optic cable. In one or more embodiments, the light transmissive interface has a cross-sectional area at least two orders of magnitude greater than a corresponding cross-sectional area of the signal carrying fibers of the first and second fiber optic cables, meaning that the cross-sectional area of the light transmissive interface is at least two orders of magnitude greater than the cross-sectional area of either of the signal carrying fibers of the first and second fiber optic cables. In one or more alternate embodiments, the light transmissive interface has a cross-sectional area at least four orders of magnitude greater than a corresponding cross-sectional area of the signal carrying fibers of the first and second fiber optic cables.

The first transmission signal is an optical signal propagating within the first fiber optic cable. Upon arriving at the first connecting module the first transmission signal is actively converted into the optical connection signal, typically an optical signal having a greater signal power than that of the first transmission signal. This active signal conversion can be achieved by configuring the first connecting module such that the first transmission signal interacts with an optical amplifier, which converts the first transmission signal into the optical connection signal having greater signal power. As noted, the optical connection signal is transmitted across a light transmissive interface from the first connecting module to the second connecting module. In one or more embodiments, the first connecting module comprises a plurality of optical amplifiers. In one embodiment, the optical connection signal power is at least an order of magnitude greater than the first transmission signal power.

In some embodiments, the second connecting module actively converts the optical connection signal into the second transmission signal. In alternate embodiments, the second connecting module receives the optical connection signal and propagates the optical connection signal within the second fiber optic cable directly, without any active transformation of the optical connection signal. For example, in one embodiment, the second connecting module comprises a focusing lens configured to passively direct the optical connection signal to the second fiber optic cable and propagate the optical connection signal within the second fiber optic cable. In the embodiment just described, notwithstanding the fact that the optical connection signal has not been actively transformed or converted in any way by the second connecting module, the signal propagated within the second fiber optic cable qualifies as a second transmission signal for purposes of this disclosure.

In an alternate embodiment, the second connecting module receives the optical connection signal, actively converts it into the second transmission signal and propagates it within the second fiber optic cable. In one embodiment, the optical connection signal interacts with an optical amplifier of the second connecting module, which actively converts the optical connection signal into a second transmission signal for propagation within the second fiber optic cable. In one or more embodiments, the second connecting module comprises a plurality of optical amplifiers.

The fidelity of data passing through an optical connector provided by the present invention can be enhanced through the use of standard data packets having known characteristics (signals which can be identified as control signals and whose data content is fixed beforehand). Such standard data packets can be used to calibrate the optical connectors for use in diverse applications and environments. In addition, the use of such standard data packets can be used to detect and correct data loss and/or distortion using methods known to those of ordinary skill in the art.

In one aspect, the optical connectors provided by the present invention offer advantages when first establishing a fiber optic cable connection between an installation configured to transmit and/or receive data via a fiber optic data transmission network. For example, in some applications it may be desirable to establish a fiber optic cable network connection between a remote installation and a control center as one of the final steps carried out prior to first operation of the installation. For example, a subsea installation, such as a large, multicomponent subsea fluid processing station, may be deployed on the sea floor prior to connecting the installation to a fiber optic data transmission network in order to prevent damage to delicate network components as the more massive components of the installation are arranged at the installation site.

Various components of the installation may be equipped with connecting modules linked via one or more fiber optic cables to installation devices such as, for example, sensors and motors. At various points during the deployment of the installation, connections to a fiber optic data transmission network may be made. Thus, in one embodiment, a deployed, but unconnected installation comprises a first connecting module configured to transmit data to and from various components of the installation via one or more fiber optic cables arrayed within the installation. In various embodiments, however, the challenge of connecting the first connecting module linked to the installation, to a second connecting module linked to a fiber optic data transmission network may be considerable and require the use of, for example, remotely operated vehicles (ROVs).

Those of ordinary skill in the art will appreciate, for example, the difficulty attending remote connection of a subsea installation with a fiber optic data transmission network linked to a surface controller. In one aspect, the present invention provides a simplified means of establishing such connections since the optical connectors disclosed herein obviate the need for a precision alignment of a signal carrying fiber of a fiber optic cable of the installation with a signal carrying fiber of the fiber optic data transmission network. With greater geometric latitude available, a first connecting module attached to the installation may be optically connected to a second connecting module linked to the network using simple connection strategies to establish a communications junction through which data may reliably pass. In some embodiments, the first connecting module and second connecting module need not be in actual physical contact in order for the optical connection signal to be passed reliably from the first connecting module to the second connecting module. In alternate embodiments, the first connecting module and second connecting module are physically joined via a mechanical or magnetic coupling. For example, the first connecting module may be coupled to the second connecting module via a sheath configured to envelop a portion of each connecting module. Alternatively, the first connecting module may be mechanically coupled to the second connecting module via one or more of a magnetic coupling, a mortise and tenon coupling, a post and slot coupling, a snap fit coupling, a cantilevered arm coupling, and a power plug and socket coupling. The couplings are designed to be robust and easily established. In one or more embodiments, the coupling, formed by joining the first connecting module to the second connecting module, is adapted to be created remotely, as for example, when the first connecting module is joined to the second connecting module with the aid of a remotely operated vehicle.

In one or more embodiments, the first connecting module and second connecting module are configured to permit movement of one or both connecting modules during operation. For example, in one embodiment, the first connecting module and the second connecting module are configured such that the first connecting module may rotate relative to a fixed second connecting module, as for example when the first connecting module is mounted on a rotating installation, such as a rotating wind turbine component, and the second connecting module is mounted on a stationary surface.

As will become apparent to those of ordinary skill in the art upon reading this disclosure, links between fiber optic cables and connecting modules of the present invention may be created with any precision required within a conventional manufacturing environment prior to deployment. Thus, any spatial or other relationships between the fiber optic cables and components of the connecting modules can be established during normal production. For example, fiber optic data transmission components destined for inclusion in an installation prior to its connection to a fiber optic data transmission network, can be factory-installed with fiber optic cable links to installation components and at least one connecting module. Similarly, links between a second connecting module and one or more components of a fiber optic data transmission network can be created during the manufacture of network components under suitably controlled manufacturing conditions.

In one or more embodiments, a first connecting module is configured to be hermetically joined to the first fiber optic cable. For example, a first connecting module may comprise a housing defining an interior space within which is disposed an optical amplifier and a power source, for example a battery, the battery being connected to and providing power to the optical amplifier. A portion of the housing wall is constituted by a light transmissive window. The housing defines an inlet passage through which a first fiber optic cable may be inserted and hermetically joined to the first connecting module. For example, a portion of the exterior surface of the fiber optic cable may be coated with a curable sealant, and the coated portion of the fiber optic cable inserted into the inlet passage of the connecting module. The sealant may then be cured to effectively isolate the interior of the first connecting module from the environment. The first connecting module is designed such that its attachment to the first fiber optic cable may be carried out in a controlled atmosphere, at superambient, ambient, or subambient pressures. In one embodiment, a simple battery-powered connecting module connected to a fiber optic cable may be elaborated by blow molding a thermoplastic material to provide a housing defining an interior cavity, a fiber optic cable inlet passage, an aperture configured to accommodate a light transmissive window, and coupling means for joining the connecting module to another connecting module. One or more battery powered optical amplifiers is positioned within the interior cavity and fixed therein. A fiber optic cable is inserted into the inlet passage and aligned with a receiver of the optical amplifier. The inlet passage may then be hermetically sealed. Any optical shielding desired may then be positioned within the interior cavity, and the light transmissive window inserted into and sealed within the corresponding aperture.

The connecting modules may be constructed of any suitable materials. For example, the housing may be constructed of stainless steel and the light transmissive window of glass. In one or more embodiments the entire housing is constructed of a light transmissive engineering thermoplastic, such as polycarbonate. In one or more embodiments, the housing is constructed of a filled plastic material, such as VALOX polyester resins available from SABIC, Inc. (Pittsfield, Mass., USA).

Typically, a connecting module requires electric power in order to actively convert a first transmission signal into an optical connection signal, and to actively convert the optical connection signal into a second transmission signal. Under such circumstances each of the first connecting module and the second connecting module will comprise optical amplifiers and each optical amplifier will require a source of electrical power. Typically, an installation to be monitored using a fiber optic data transmission network will be powered via one or more electric power transmission cables linked to an electric power grid or to one or more generators. As such, a first connecting module linked to the installation may be conveniently provided with electric power taken from the installation. A second connecting module also requiring electric power may be powered through electrical contacts to the first connecting module. In this manner duplication of power supply infrastructure to the installation and the connecting modules of the optical connector can be avoided.

Under some conditions it may be desirable to provide power to the connecting modules via a fiber optic data transmission network and even to the installation being monitored, as might be the case where use of the installation was intermittent and relatively small amounts of power were needed to make use of it. Under such circumstances electric power would be provided directly to the second connecting module. The first connecting module would be powered through electrical contacts to the second connecting module. The installation would be powered through electrical contacts to the first connecting module.

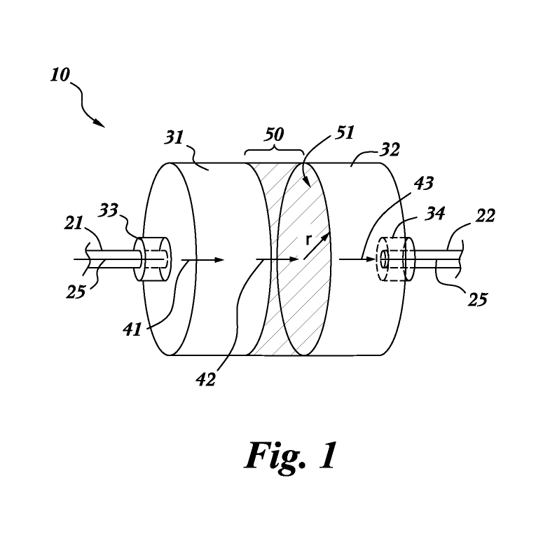

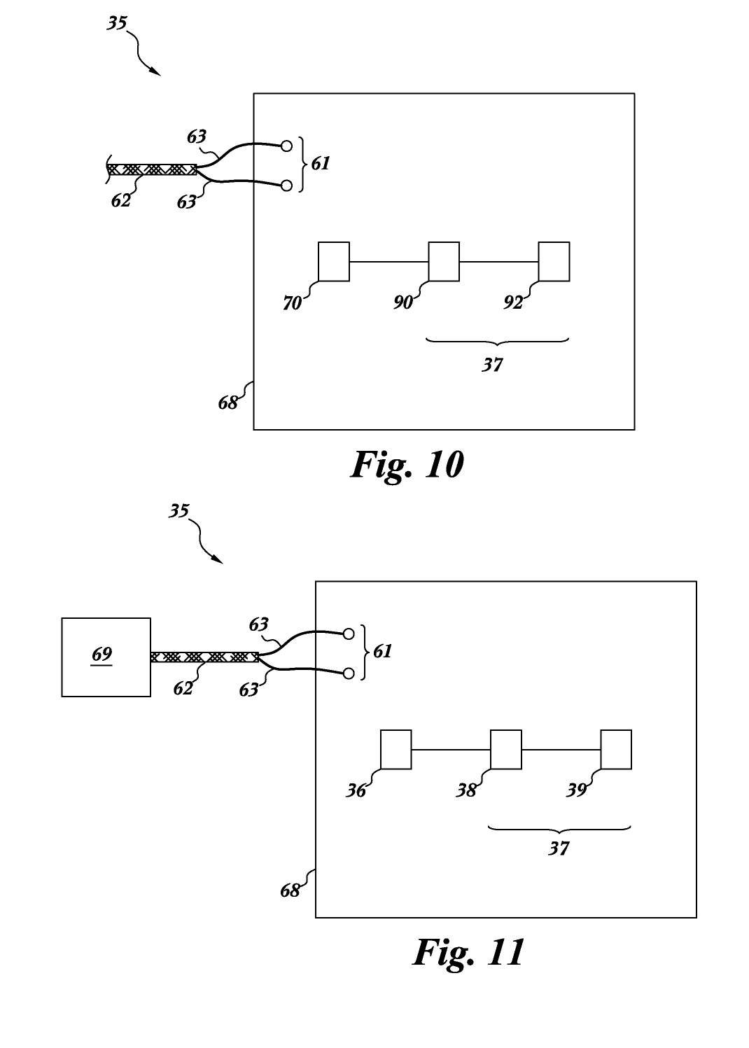

Turning now to the figures, FIG. 1 represents an optical connector 10 provided by the present invention. In the embodiment shown, the optical connector comprises a first connecting module 31 hermetically joined to a first fiber optic cable 21 via sealed fiber optic cable connection 33. The first connecting module is shown as configured to receive a first transmission signal 41 from a signal carrying fiber 25 of the first fiber optic cable. First transmission signal 41 is actively converted by an optical amplifier (not shown) of first connecting module 31 into optical connection signal 42 which is transmitted across light transmissive interface 50 to second connecting module 32. Light transmissive interface 50 is depicted in FIG. 10 as a cylindrical gap having radius r between a light transmissive window of the first connecting module and a light transmissive window of the second connecting module 32. As such, the light transmissive interface 50 has cross-sectional area 51 equal to πr². Optical connection signal 42 enters second connecting module 32 where it is converted into second transmission signal 43 which is then propagated within second fiber optic cable 22. In the embodiment shown, second fiber optic cable 22 is hermetically joined to second connecting module 32 via sealed fiber optic cable connection 34. Further, in the embodiment shown, the interior of each of connecting modules 31 and 32 is hermetically sealed from the environment. In one or more embodiments, cross-sectional area 51 is at least two orders of magnitude greater than the corresponding cross-sectional area of either of signal carrying fibers 25.

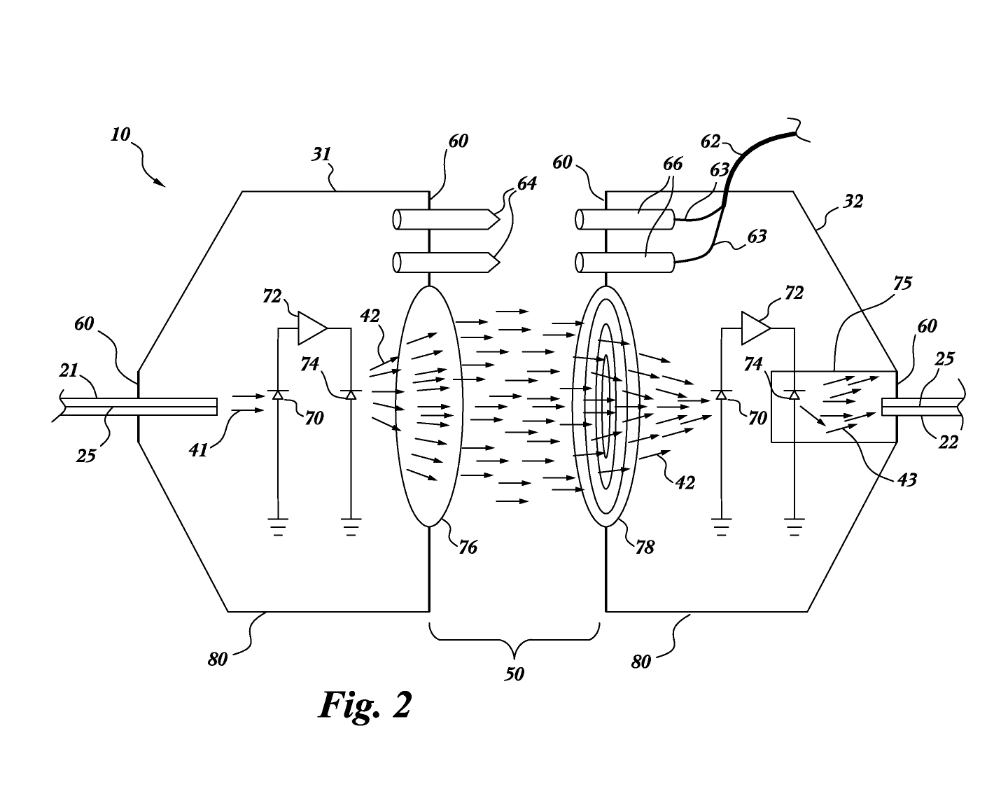

Referring to FIG. 2, the figure represents an exploded view of an optical connector 10 provided by the present invention and comprising a first connecting module 31 and a second connecting module 32, the two connecting modules representing key components of a communications junction. First connecting module 31 is configured to receive a first transmission signal 41 from a signal carrying fiber 25 of a first fiber optic cable 21 and to actively convert the first transmission signal into an optical connection signal 42 using an optical amplifier comprising a photodetector 70, an amplifier 72 and a light emitting diode 74. Thus, an optical signal, first transmission signal 41, is delivered to first connecting module 31 and impinges on photodetector 70 which converts the first transmission signal into an electric signal which is amplified by amplifier 72 and converted back into an optical signal, optical connection signal 42, at light emitting diode 74. In the embodiment shown, optical connection signal 42 has a greater optical signal power than first transmission signal 41.

Still referring to FIG. 2, optical connection signal 42 is transmitted through optical lens 76, which may be for example a dispersion lens, and across light transmissive interface 50 to second connecting module 32. The optical connection signal 42 enters via focusing lens 78 and is actively converted to into second transmission signal 43 by an optical amplifier comprising photodetector component 70, an electric signal amplifier 72 and a light emitting diode 74. In the embodiment shown, the second transmission signal 43 is propagated within second fiber optic cable 22 using a fiber optic cable signal input connector 75 which enforces proximity between light emitting diode 74 and the signal carrying fiber 25 of second fiber optic cable 22.

Still referring to FIG. 2, each of connecting modules 31 and 32 comprises a housing 80 and hermetic seals 60 which assure that the components disposed within the connecting modules are protected from contact with the environment. In the embodiment shown, electric power is provided to first connecting module 31 via second connecting module through the agency of power pins 64 and power sockets 66. Power supply cable 62 provides electric power to second connecting module 32. Power supply leads 63 connect power supply cable to power sockets 66. Although not shown in FIG. 2, it will be understood by those of ordinary skill in the art that the optical amplifiers represented by the combination of photodetectors 70, amplifiers 72 and light emitting diodes 74 require electric power and may be connected through power supply leads (not shown) to power pins 64 or power supply cable 62. During operation the connecting modules are joined to one another through power pins 64 and power sockets 66.

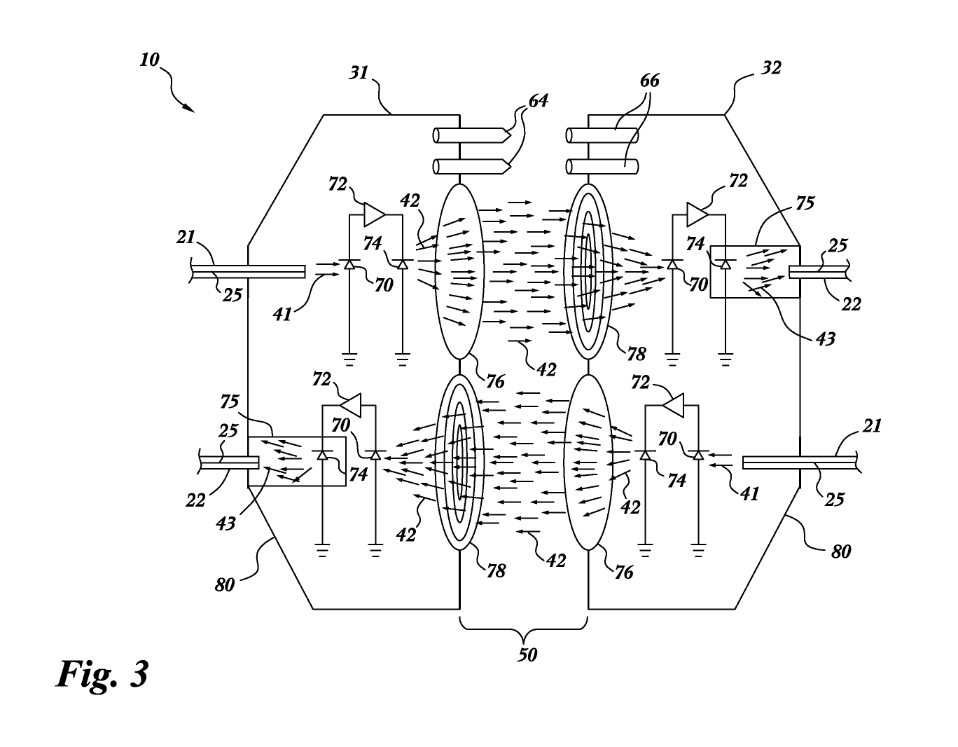

Referring to FIG. 3, the figure represents an optical connector provided by the present invention wherein each of connecting modules 31 and 32 is configured to receive a first transmission signal 41 and to send a second transmission signal 43. In the embodiment shown, the optical connector 10 comprises a plurality (four in number) of optical amplifiers each comprising a photodetector 70 configured to convert an optical signal (41 or 42) into a corresponding electrical signal, an electric signal amplifier 72, and light emitting diode 74 configured to receive an electric signal from amplifier 72 and convert the electric signal into an optical signal (42 or 43). In addition, each of connecting modules 31 and 32 is hermetically joined to a plurality of fiber optic cables.

In the embodiment shown, a first transmission signal 41 is delivered to the interior of first connecting module 31 where it impinges upon a photodetector 70 of a first optical amplifier, which converts the first transmission signal into an optical connection signal 42, which is transmitted through dispersion lens 76 and across light transmissive interface 50, to the second connecting module 32. In the embodiment shown, the optical connection signal 42 is enhanced in optical signal power relative to signal power of the first transmission signal 41 by at least an order of magnitude. Optical connection signal 42 enters connecting module via focusing lens 78 which directs the optical connection signal to a photodetector 70 of a second optical amplifier, which converts the optical connection signal first into an electric signal, which is amplified by electric signal amplifier 72, and is thereafter converted to second transmission signal 43, which is propagated in second fiber optic cable 22. Fiber optic cable signal input connector 75 enforces proximity between the light emitting diode 74 of the second optical amplifier and the end of second fiber optic cable 22, which is configured to receive second transmission signal 43. In one or more embodiments, a fiber optic cable signal input connector may be used to enforce proximity between a fiber optic cable delivering a first transmission signal to a connecting module and an optical amplifier component of the connecting module, such as a photodetector. The use of fiber optic cable signal input connectors may be useful to prevent unintended interactions between one or more light sources and a fiber optic cable or a photodetector of the optical connector provided by the present invention.

Still referring to FIG. 3, second connecting module 32 is also configured to receive a first transmission signal 41 from a first fiber optic cable 21. It should be noted that first fiber optic cable 21 attached to second connecting module 32 is distinct from the first fiber optic cable 21 attached to first connecting module 31, and that the optical connector depicted in FIG. 3 is connected to four different fiber optic cables, two indicated by element number 21 and each being referred to as first fiber optic cable 21, and two indicated by element number 22 and each being referred to as second fiber optic cable 22. It should be noted that each of the connecting modules may be configured to simultaneously receive first transmission signals 41, and thereafter transmit the corresponding optical connection signals 42 after a time interval required to convert the first transmission signals into the corresponding optical connection signals. In one embodiment, data may pass simultaneously in different directions through an optical connector 10 configured as shown in FIG. 3. In an alternate embodiment, the optical amplifiers of the connecting modules are configured such that simultaneous transmission of optical connection signals in opposite directions is prevented using a delay circuit of a first optical amplifier which senses transmission of an optical connection signal by a second optical amplifier and delays the generation of an optical connection signal by the first optical amplifier during the time interval the second optical amplifier transmits its optical connection signal.

In the embodiment shown, the two connecting modules 31 and 32 are configured to be joined to form an optical communications junction by insertion of power pins 64 into power sockets 66 which in the embodiment shown are sized and configured to reliably connect the connecting modules. A power supply cable 62 (not shown) may provide electric power to either of connecting modules 31 and 32, the other of which receives electric power via the connection formed between power pins 64 and power sockets 66. Power supply leads 63 (not shown) provide electric power to the four optical amplifiers, which may be mounted on circuit boards within the connecting modules.

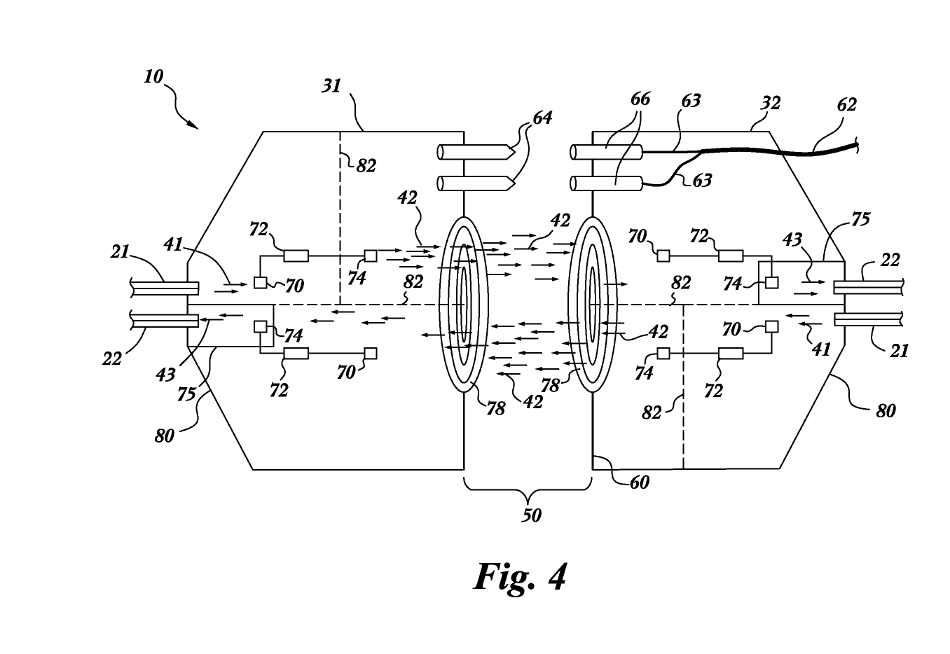

Referring to FIG. 4, the figure represents an optical connector 10 provided by the present invention and comprising a first connecting module 31 and a second connecting module 32. Each connecting module is connected to a first fiber optic cable 21 and a second fiber optic cable 22. As in the embodiment shown in FIG. 3, each of the four fiber optic cables is a distinct and different fiber optic cable. The two first fiber optic cables 21 are configured to deliver first transmission signals 41 to the first connecting module and second connecting module respectively. The two second fiber optic cables are configured to carry second transmission signals 43 from the first connecting module and second connecting module respectively. Each connecting module comprises a pair of optical amplifiers, each optical amplifier comprising a photodetector 70, an electric signal amplifier 72 and a light emitting diode 74. In the embodiment shown, the optical amplifiers are shielded from one another within the same connecting module by optical shielding 82 which prevents unintended interaction of, for example, light generated by a light emitting diode 74 of one of the pair of optical amplifiers with the photodetector 70 of the other optical amplifier. Various types of optical shielding are known to those of ordinary skill in the art.

In the embodiment shown, each connecting module comprises a single light transmissive window represented here as focusing lenses 78. As noted in the discussion of the embodiment represented by FIG. 3 herein, optical connection signals 42 may be transmitted simultaneously through optical lenses 78 in both directions (31 to 32 and 32 to 31) across light transmissive interface 50. Alternatively, the optical connector electronics may be configured such that while the first of a pair of optical amplifiers within a connecting module is receiving an optical connection signal 42, the second optical amplifier of the pair may not transmit an optical connection signal across the same light transmissive interface. In one or more embodiments, each optical amplifier comprises a delay circuit which stores the signal received from a photodetector 70 of the first optical amplifier of the connecting module (e.g. 31) during the time interval in which the photodetector 70 of the second optical amplifier of the connecting module receives an optical connection signal 42.

In the embodiment shown, electric power is provided to the first connecting module 31 from the second connecting module 32 via the electrical connection represented by power pins 64 and power sockets 66. Electric power is provided to second connecting module via power supply cable 62.

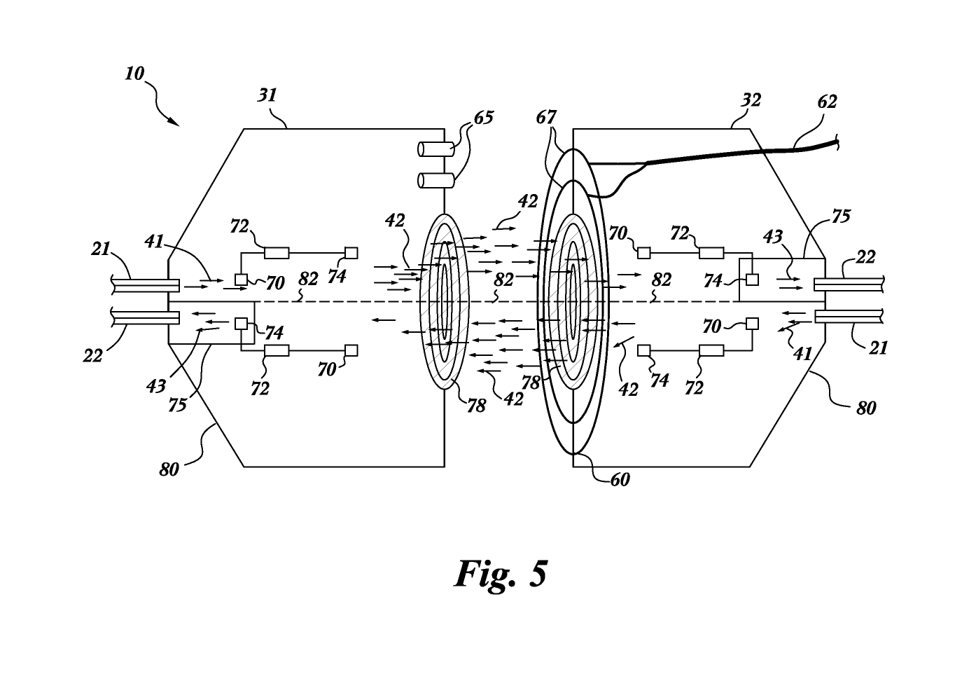

Referring to FIG. 5, the figure represents an optical connector 10 provided by the present invention and configured as in FIG. 4 with the exception that power is provided to the first connecting module 31 from the second connecting module 32 via the electrical connection represented by power contacts 65 and power slip rings 67. As will be appreciated by those of ordinary skill in the art, the use of such a power supply arrangement enables one or both connecting modules to rotate relative to the other while remaining in electrical contact. An additional difference relative to the embodiment shown in FIG. 4 is that optical shielding 82 is present in both of the connecting modules, optical lenses 78, and light transmissive interface. In one or more embodiments, the optical shielding used within the light transmissive interface is a baffle permanently attached to one of the first connecting module or the second connecting module. The other connecting module may comprise a complementary structure, (e.g. a notch, a groove, or a slot) with which a suitable portion of the baffle may be mated.

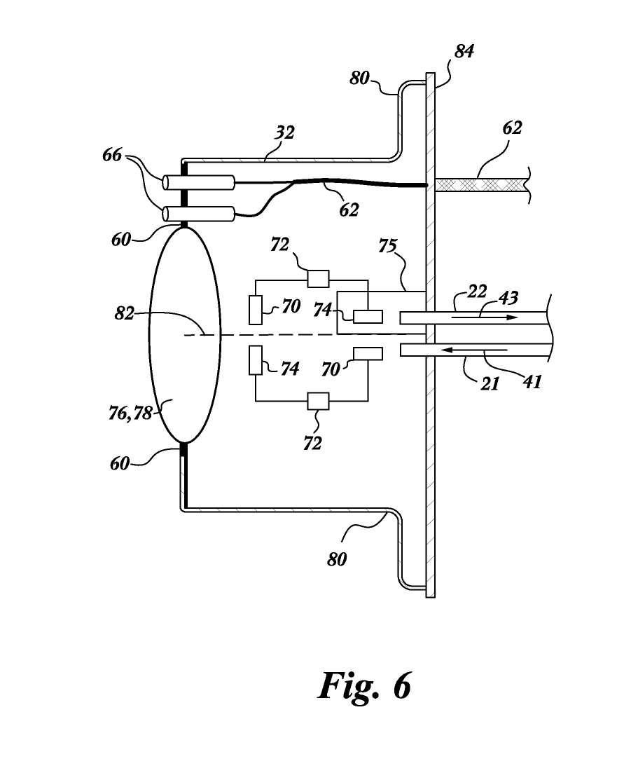

Referring to FIG. 6, the figure represents a connecting module provided by the present invention comprising a flange mount 84 suitable for attachment to an installation configured to receive and transmit data via a fiber optic data transmission network. In one embodiment, the connecting module as illustrated in FIG. 6 is a second connecting module 32 to which a first connecting module linked to a fiber optic data transmission network may be connected after deployment of an installation but prior to its becoming operational.

In the embodiment shown, the connecting module comprises a pair of optical amplifiers each comprising a photodetector 70, an electric signal amplifier 72, and a light emitting diode 74. Optical shielding 82 separates the optical amplifiers and bisects optical lens 76/78. The interior of the connecting module is hermetically sealed from the environment within housing 80 using hermetic seals 60 known those of ordinary skill in the art. The connecting module illustrated in FIG. 6 is configured to be powered by the installation to which it is attached via power supply cable 62.

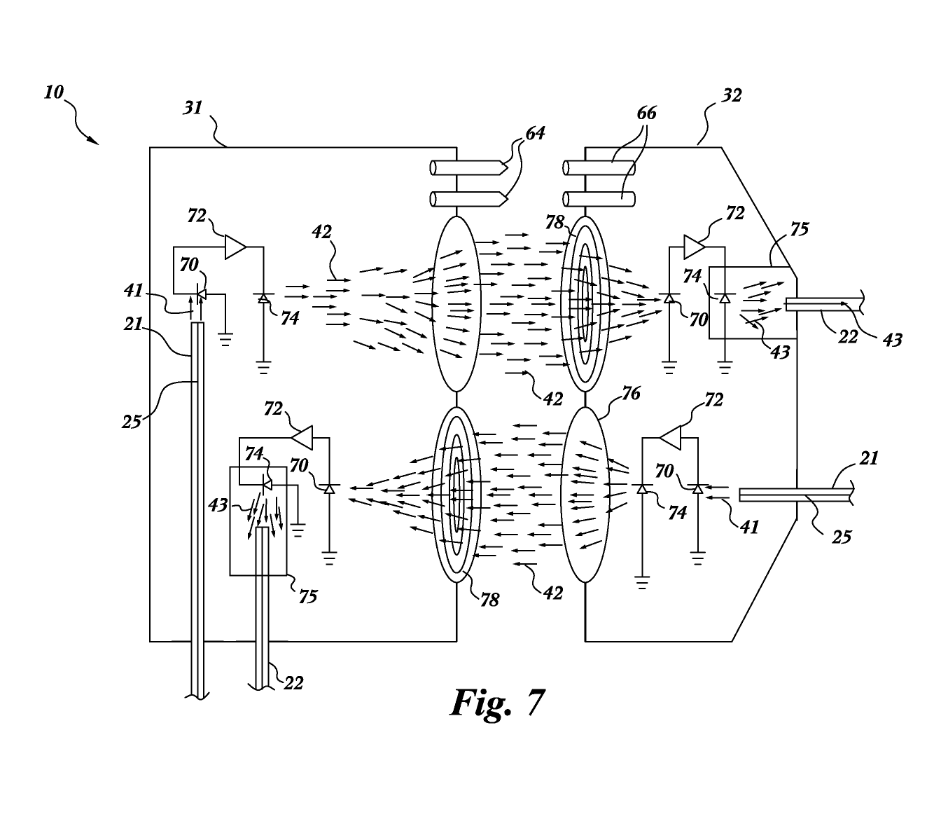

Referring to FIG. 7, the figure represents an optical connector provided by the present invention in which the fiber optic cables (21/22) of the first connecting module 31 and the fiber optic cables (21/22) of the second connecting module 32 define an angle between the first set of fiber optic cables and the second set of fiber optic cables which is approximately ninety degrees. Such an arrangement may at times herein be referred to as a “right angle” fiber optic cable configuration. The optical connector shown in FIG. 7 is otherwise essentially the same as that illustrated in FIG. 3. The right angle fiber optic cable configuration is beneficial in applications wherein the geometry of the optical connector is constrained by its location on an installation to be other than the one hundred eighty degree arrangement (at times herein referred to as a linear configuration) of the fiber optic cables illustrated in FIGS. 1-5.

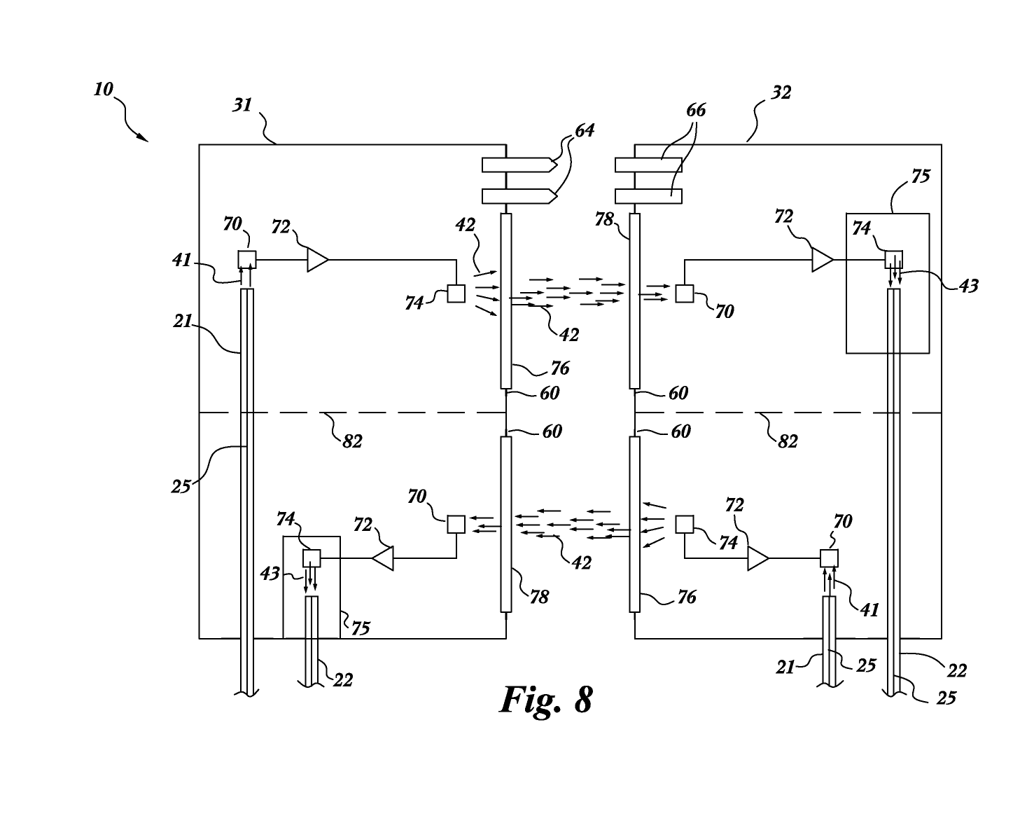

Referring to FIG. 8, the figure represents an optical connector provided by the present invention and configured essentially as in FIGS. 3 and 7 with the exception that the optical amplifier systems comprising a photodetector 70, an electric signal amplifier 72 and a light emitting diode 74 are separated within their respective connecting modules (31/32) by optical shielding 82. In addition, the fiber optic cables are configured such that the fiber optic cables (21/22) of the first connecting module 31, and the fiber optic cables (21/22) of the second connecting module 32 define an angle between the first set of fiber optic cables and the second set of fiber optic cables which is approximately zero degrees. Such an arrangement may at times herein be referred to as a “horseshoe” fiber optic cable configuration.

As will be evident to those of ordinary skill in the art having read the foregoing discussion of embodiments represented by FIG. 7 and FIG. 8; the first and second connecting modules may be configured to couple such that an angle defined by a first fiber optic cable attached to the first connecting module and a second fiber optic cable attached to the second connecting module define an angle which may range from 0 degrees (horseshoe fiber optic cable configuration) to 180 degrees (linear configuration). Thus, in one embodiment, the first connecting module and the second connecting module are configured to couple such that an angle defined by the first fiber optic cable and the second fiber optic cable is less than 180 degrees. In an alternate embodiment, the first connecting module and the second connecting module are configured to couple such that an angle defined by the first fiber optic cable and the second fiber optic cable is less than 90 degrees.

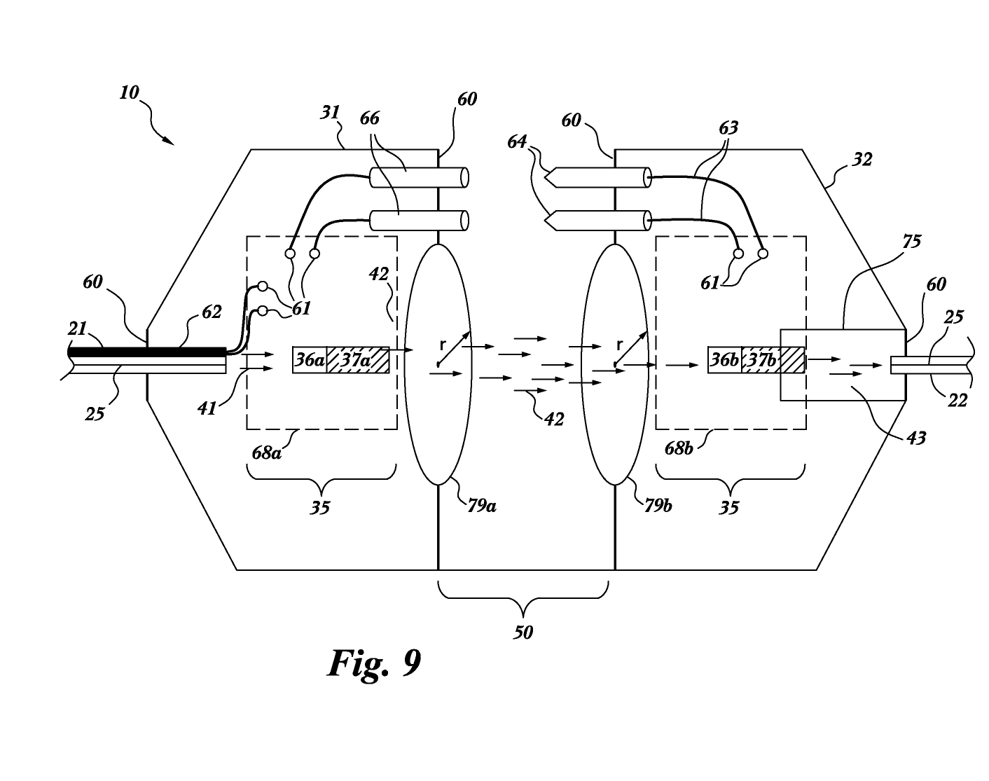

Referring to FIG. 9, the figure represents an optical connector provided by the present invention. In the embodiment shown, connecting modules 31 and 32 are configured to be joined by inserting power pins 64 into power sockets 66. Power pins and power sockets are sized for ease of union and may be positioned anywhere on the surfaces to be joined. Power is delivered to first connecting module 31 via power supply cable 62 which may form a part of first fiber optic cable 21. Power supply cable 62 delivers electric power to first circuit board 68a and power sockets 66 through power connections 61 on the circuit board and the four power supply leads shown in first connecting module 31 (element 63 in second connecting module 32). Power is supplied to the second connecting module via power pins 64, power supply leads 63 and circuit board power connections 61 of second circuit board 68b. Each connecting module comprises an optical amplifier 35 mounted on a first circuit board 68a and second circuit board 68b respectively. The optical amplifier of the first connecting module comprises a first receiver 36a and a first signal conversion system 37a. Similarly, optical amplifier 35 of second connecting module 32 comprises a second receiver 36b and a second signal conversion system 37b. Receivers 36a and 36b are configured to receive a first transmission signal 41 and optical connection signal 42 respectively, and to convert the optical signal received into an electric signal which is then processed by signal conversion systems 37a and 37b respectively. First signal conversion system 37a converts the electric signal received from first receiver 36a into optical connection signal 42. Optical connection signal 42 is transmitted through first light transmissive window 79a, across light transmissive interface 50 and second light transmissive window 79b into the interior of second connecting module 32 where it interacts with second receiver 36b. Second receiver 36b converts the optical connection signal into an electrical signal which is then processed by second signal conversion system 37b to provide second transmission signal 43.

In one or more embodiments, first receiver 36a and second receiver 36b may be any device known to convert an optical signal to an electric signal, for example, a photodiode. Signal conversion systems 37a and 37b may be any device which may be used to convert an electrical signal into an optical signal. In one embodiment, at least one of signal conversion systems 37a and 37b comprises a laser driver and a laser.

In the embodiment shown in FIG. 9, first and second light transmissive windows 79a and 79b are circular and are characterized by radii r and cross-sectional areas πr². In one or more embodiments, the cross-sectional areas of the light transmissive windows are such that the light transmissive interface 50 through which optical connection signal 42 is transmitted, is itself characterized by a cross-sectional area which is at least two orders of magnitude greater than the corresponding cross-sectional areas of the signal carrying fibers 25 of the first and second fiber optic cables 21 and 22. The cross-sectional areas of light transmissive windows 79a and 79b may be the same or different. In one embodiment, first light transmissive window 79a is a diffusion lens and second light transmissive window 79b is a focusing lens.

Referring to FIG. 10, the figure represents an optical amplifier 35 which may be employed according to one or more embodiments of the present invention. In the embodiment shown, the optical amplifier is mounted on a circuit board 68 and comprises a photodetector 70 linked to laser driver 90 and a laser 92, the laser driver and laser together representing a signal conversion system 37. Power is supplied to the optical amplifier via power supply cable 62, power supply leads 63 and circuit board power connections 61.

Referring to FIG. 11, the figure represents an optical amplifier 35 which may be used according to one or more embodiments of the present invention. The optical amplifier comprises a receiver 36, electric signal amplifier 38, and signal converter 39 mounted on circuit board 68 and powered by battery 69.

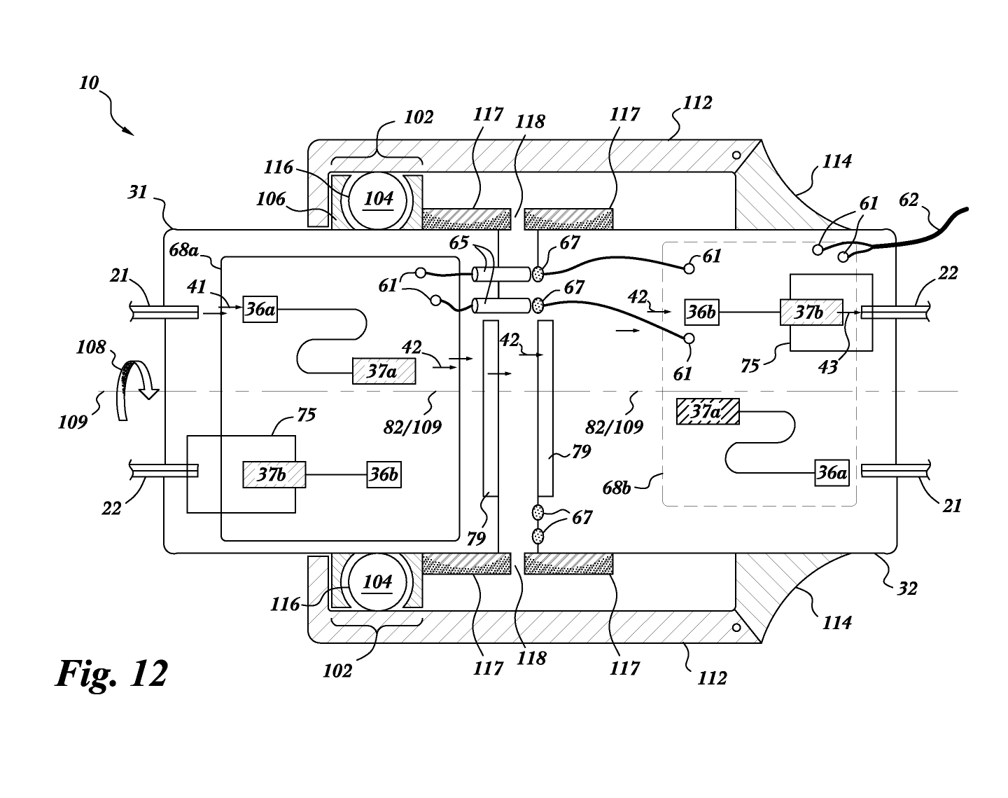

Referring to FIG. 12, the figure represents an optical connector 10 provided by the present invention in which at least one of the first connecting module and the second connecting module is configured to rotate. In the embodiment shown, first connecting module 31 comprises a bearing 102 comprising bearing rollers 104 disposed within a bearing housing 106 attached to the outer surface of first connecting module 31 housing 80 (See FIG. 5). The first connecting module is rotably joined to second connecting module 32 via a plurality of cantilevered locking arms 112 which extend over and beyond bearing housing 106. Cantilevered locking arms 112 are configured to contact the surface of bearing roller 104 but not otherwise contact the bearing 102. Thrust bumpers 117 and associated gap 118 are sized to prevent unwanted contact between the bearing and the cantilevered locking arms. While not drawn to scale in FIG. 12, those of ordinary skill in the art will appreciate that gap 118 between thrust bumpers 117 will be smaller than the gap between the cantilevered locking arms and the surface of the bearing housing closest to fiber optic cables 21 and 22 of first connecting module 31. Cantilevered locking arms are joined to the outer surface of the second connecting module via support structure 114. First connecting module 31 and second connecting module 32 are joined by positioning the connecting modules such that the power contacts 65 of connecting module 31 are in electrical contact with power slip rings 67 of connecting module 32, while the cantilevered locking arms 112 are in the “up” position. The cantilevered locking arms may then be lowered into a locked position and reliably connect the two modules.

In one embodiment, second connecting module 32 is configured to rotate around axis of rotation 109 in direction 108 while first connecting module 31 remains stationary. In an alternate embodiment, the first and second connecting modules are configured to rotate in opposite directions. In yet another embodiment, the first connecting module 31 is configured to rotate in direction 108 while the second connecting module 32 remains stationary.

In the embodiment shown, each connecting module comprises two optical amplifiers each comprising first and second receivers 36a and 36b, and first and second signal conversion systems 37a and 37b. Within a connecting module, each optical amplifier is shielded from the other by means of optical shielding 82. Power supply cable 62 provides electric power to second connecting module 32 which in turn powers first connecting module 31 via power slip rings 67 and electrical contacts 65.

### Example

The following example provides additional detailed guidance for the practice of the invention. Thus, in one embodiment, an electronic semiconductor photodetector, such as Edmund Optics part number 54-034, mounted on a suitable circuit is interfaced with the end of a fiber optic cable within a first connecting module also comprising an electronic signal amplifier and a light emitting diode. The interface between the fiber optic cable and the photodetector is assembled and permanently sealed in a clean manufacturing environment. In response to a first transmission signal, the photodetector produces an electric communication signal which is transmitted to the electronic signal amplifier, such as a Texas Instruments OPA365, which conditions the electric communication signal received from the photodetector. The conditioned electrical signal from the amplifier is then applied to the light emitting diode, such as a Lumex OED-EL-1L2, to convert the electrical signal to an optical connection signal. The optical connection signal from the light emitting diode is directed toward a flat, transparent lens having a cross-sectional area of about two square inches, the lens being positioned a few inches from the light emitting diode. The transparent, flat lens forms one end of the optical connector which is entirely sealed at the factory.

A second connecting module, designated the receiving side of the optical connector, is configured to abut the transparent flat lens of the first connecting module and comprises a Fresnel lens, for example an Edmund Optics lens 43-024 having a cross-sectional area of about two square inches. The Fresnel lens is configured to receive the optical connection signal as it traverses a light transmissive interface (gap) between the two connecting modules. The light transmissive interface has a cross-sectional area of about two square inches. The Fresnel lens focuses the optical connection signal onto a second photodetector. An Edmund Optics photodetector having part number 54-034 is suitable for both the first and second photodetectors. The second photodetector converts the optical connection signal into an electric signal, which is amplified/conditioned by an electronic amplifier. The same model of electronic amplifier may be used in both the first and second connecting modules (e.g. a Texas Instruments OPA365). The conditioned electrical signal is then applied to a second light emitting diode which converts the conditioned electrical signal to an optical signal referred to as the second transmission signal. The second connecting module is configured such that the second light emitting diode is in intimate contact with the end of a second fiber optic cable. Thus, the second transmission signal generated by the second light emitting diode is propagated within a signal carrying fiber of the second fiber optic cable. The entire second connecting module assembly from the Fresnel lens to the fiber optic cable is entirely assembled and sealed in a clean manufacturing environment. Electronics within the first and second connecting modules are powered by battery packs mounted on the housing of each connecting module.

In practice, one of the connecting modules is attached to an installation to be monitored and controlled. The other connecting module is connected via its fiber optic cable to a fiber optic data transmission network. The two connecting modules can be joined to form the completed optical connector by any convenient means, for example a plastic sheath configured to enforce proximity of the two lenses of the optical connector. Joining the two connecting modules to form the completed optical connector can be carried out in a wide variety of environments since there is no requirement for precision alignment of the two connecting modules or even that the surfaces of the lenses be particularly clean. This is because the cross-sectional area of the light transmissive interface is large compared with that of a conventional fiber optic connector, wherein the cross-sectional area of the light transmissive interface between two signal carrying fibers is on the order of five millionths of a square inch (5×10⁻⁶ inch²). Thus, the robustness of the optical data transmission junction may be enhanced by several orders of magnitude.

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. An optical connector comprising:
(a) a first connecting module configured to be joined to a first fiber optic cable, the first connecting module being configured to receive a first transmission signal from a signal carrying fiber of the first fiber optic cable and to actively convert the first transmission signal into an optical connection signal; and
(b) a second connecting module configured to be joined to a second fiber optic cable, the second connecting module being configured to receive the optical connection signal and to propagate a second transmission signal within a signal carrying fiber of the second fiber optic cable;
wherein the first connecting module comprises at least one optical amplifier, and wherein the first and second connecting modules are configured to couple such that the optical connection signal is transmitted and received across a light transmissive interface.

2. The optical connector according to claim 1, wherein the light transmissive interface has a cross-sectional area at least two orders of magnitude greater than a corresponding cross-sectional area of the signal carrying fibers of the first and second fiber optic cables.

3. The optical connector according to claim 1, comprising a plurality of optical amplifiers.

4. The optical connector according to claim 1, wherein the optical amplifier comprises a photodetector configured to convert the first transmission signal into an electric signal.

5. The optical connector according to claim 4, further comprising a laser driver and a laser.

6. The optical connector according to claim 4, further comprising an electric signal amplifier and a light emitting diode.

7. The optical connector according to claim 1, comprising a plurality of light emitting diodes.

8. The optical connector according to claim 1, wherein the second connecting module is configured to actively convert the optical connection signal into a second transmission signal and to propagate the second transmission signal within a signal carrying fiber of the second fiber optic cable.

9. The optical connector according to claim 1, wherein the light transmissive interface comprises a dispersion lens and a focusing lens.

10. The optical connector according to claim 1, wherein the first connecting module and the second connecting module are configured to couple such that an angle defined by the first fiber optic cable and the second fiber optic cable is less than 180 degrees.

11. The optical connector according to claim 1, wherein the first connecting module and the second connecting module are configured to couple such that an angle defined by the first fiber optic cable and the second fiber optic cable is less than 90 degrees.

12. The optical connector according to claim 1, wherein at least one of the first connecting module and the second connecting module is configured to be mounted on a flange.

13. The optical connector according to claim 1, wherein at least one of the first connecting module and the second connecting module is configured to rotate.

14. The optical connector according to claim 1, wherein one of the first connecting module and the second connecting module provides electric power to the other connecting module.

15. The optical connector according to claim 1, wherein at least one of the first connecting module and the second connecting module is configured to be powered by a battery.

16. An optical connector comprising:
(a) a first connecting module configured to be joined to a first fiber optic cable, the first connecting module being configured to receive a first transmission signal from a signal carrying fiber of the first fiber optic cable and to actively convert the first transmission signal into an optical connection signal; and
(b) a second connecting module configured to be joined to a second fiber optic cable, the second connecting module being configured to receive the optical connection signal and to actively convert the optical connection signal into a second transmission signal and to propagate the second transmission signal within a signal carrying fiber of the second fiber optic cable;
wherein the first and second connecting modules are configured to couple such that the optical connection signal is transmitted and received across a light transmissive interface.

17. The optical connector according to claim 16, wherein at least one of the first connecting module and the second connecting module is configured to rotate.

18. The optical connector according to claim 16, wherein the light transmissive interface comprises a first light transmissive window and a second light transmissive window.

19. An optical connector comprising:
(a) a first connecting module configured to be hermetically joined to a first fiber optic cable, the first connecting module comprising:
(i) a first receiver configured to receive a first transmission signal characterized by a first transmission signal power from a signal carrying fiber of the first fiber optic cable and to convert the first transmission signal into a first electric signal;
(ii) a first conversion system configured to convert the first electric signal into an optical connection signal characterized by an optical connection signal power at least an order of magnitude greater than the first transmission signal power;
(iii) a first light transmissive window configured to transmit the optical connection signal;
(b) a second connecting module configured to be hermetically joined to a second fiber optic cable, the second connecting module comprising:
(i) a second light transmissive window configured to transmit the optical connection signal;
(ii) a second receiver configured to receive the optical connection signal and to convert the optical connection signal into a second electric signal;
(iii) a second conversion system configured to convert the second electric signal into a second transmission signal and to propagate the second transmission signal within a signal carrying fiber of the second fiber optic cable;
wherein the first and second connecting modules are configured to couple such that the optical connection signal is transmitted and received across a light transmissive interface having a cross-sectional area at least two orders of magnitude greater than a corresponding cross-sectional area of the signal carrying fibers of the first and second fiber optic cables.

20. The optical connector according to claim 19, wherein at least one of the first connecting module and the second connecting module is configured to rotate.

21. The optical connector according to claim 19, wherein each of the first connecting module and the second connecting module comprises a plurality of optical amplifiers and is hermetically joined to a plurality of fiber optic cables.

22. The optical connector according to claim 19, wherein the first connecting module and the second connecting module are configured to couple such that an angle defined by the first fiber optic cable and the second fiber optic cable is less than 180 degrees.

23. The optical connector according to claim 19, wherein one of the first connecting module and the second connecting module provides electric power to the other connecting module.

24. An optical connector component comprising:
a connecting module configured to be joined to a fiber optic cable, the connecting module being configured to receive a transmission signal from a signal carrying fiber of the fiber optic cable and to actively convert the transmission signal into an optical connection signal;
wherein the connecting model is configured to couple with a second connecting module and transmit the optical connection signal to the second connecting module across a light transmissive interface.

25. The optical connector component according to claim 24, further comprising a bearing configured to permit movement of the connecting module.
